(19) United States
(12) Patent Application Publication
(10) Pub. No.: US 2008/0248245 A1
(43) Pub. Date: Oct. 9, 2008

(54) Soft Magnetic Material, Method of Manufacturing Soft Magnetic Material, Dust Core, and Method of Manufacturing Dust Core

(76) Inventors: Toru Maeda, Hyogo (JP); Haruhisa Toyoda, Hyogo (JP); Naoto Igarashi, Hyogo (JP); Kazuhiro Hirose, Hyogo (JP); Seiji Ishitani, Hiroshima (JP); Hiroko Morii, Hiroshima (JP); Kazuyuki Hayashi, Hiroshima (JP)

Correspondence Address: MCDERMOTT WILL & EMERY LLP, 600 13TH STREET, N.W., WASHINGTON, DC, 20005-3096, US

(21) Appl. No.: 11/919,704

(22) PCT Filed: Jul. 20, 2006
(86) PCT No.: PCT/JP2006/314409

§ 371 Date: Oct. 31, 2007

(30) Foreign Application Priority Data
Aug. 3, 2005 (JP) 2005-225809

(51) Int. Cl. B32B 5/16; B32B 15/02; B05D 1/00; C04B 35/634

(52) U.S. Cl. 428/144; 428/403; 427/127; 264/612

(57) ABSTRACT

A soft magnetic material includes a plurality of composite magnetic particles. Each of the plurality of composite magnetic particles has a metal magnetic particle including iron, a lower film surrounding the surface of the metal magnetic particle and including a nonferrous metal, and an insulating upper film surrounding the surface of the lower film and including an inorganic compound. The inorganic compound contains at least one element of oxygen and carbon. The nonferrous metal has an affinity with at least one of oxygen and carbon that is larger than such affinity of iron. The nonferrous metal has a diffusion coefficient with respect to at least one of oxygen and carbon that is smaller than such diffusion coefficient of iron. Thus, a soft magnetic material that provides desirable magnetic properties, a method of manufacturing a soft magnetic material, a dust core, and a method of manufacturing a dust core are provided.

### TECHNICAL FIELD

The present invention generally relates to a soft magnetic material, a method of manufacturing a soft magnetic material, a dust core, and a method of manufacturing the dust core, and more particularly to a soft magnetic material, a method of manufacturing a soft magnetic material, a dust core including metal magnetic particles covered with an insulating film, and a method of manufacturing the dust core.

### BACKGROUND ART

Conventionally, attempts have been made to provide electric and electronic components such as motor and transformer cores having higher densities and smaller sizes to meet the demand for more precise control using small electric power, which has led to development of soft magnetic materials used in fabricating such electric and electronic components which provide improved magnetic properties particularly in the middle to high frequency range.

In conjunction with such soft magnetic materials, Japanese Patent Laying-Open No. 2002-246219, for example, discloses a dust core in which magnetic properties can be maintained during use in high temperatures and a method of manufacturing such a core (Patent Document 1). According to the method disclosed in Patent Document 1, atomized iron powders covered with phosphoric acid film are first mixed with a predetermined amount of polyphenylene sulfide (PPS resin) and then undergoes compression molding. The resulting molding is heated in air at a temperature of 320° C. for one hour and then heated at a temperature of 240° C. for another hour. It is then cooled to fabricate a dust core.

### DISCLOSURE OF THE INVENTION

### Problems to be Solved by the Invention

The dust core thus fabricated may include numerous distortions (dislocations, defects) in its interior, which will prevent displacement of domain walls (change in magnetic flux), resulting in a decrease in magnetic permeability of the dust core. The dust core disclosed in Patent Document 1 experiences heat treatment twice as a molding and still fails to properly eliminate internal distortion. Consequently, the effective permeability of the resulting dust core, which may vary depending on the frequency and the content of the PPS resin, always remains at low values of 400 or below.

It may also be contemplated to perform the heat treatment on the molding at higher temperatures in order to reduce distortion within the dust core to an acceptable level. However, the phosphoric acid compound covering the atomized iron powders has a low heat resistance and thus degenerates during heat treatment at high temperature. This results in phosphoric acid-covered atomized iron powders with increased eddy current loss between particles, which may reduce the permeability of the dust core.

From the foregoing, an object of the present invention is to solve the above problems by providing a soft magnetic material that provides desirable magnetic properties, a method of manufacturing a soft magnetic material, a dust core, and a method of manufacturing a dust core.

### Means for Solving the Problems

A soft magnetic material according to an aspect of the present invention includes a plurality of composite magnetic particles. Each of the plurality of composite magnetic particles has: a metal magnetic particle including iron; a lower film surrounding the surface of the metal magnetic particle and including a nonferrous metal; and an insulating upper film surrounding the surface of the lower film and including an inorganic compound. The inorganic compound contains at least any one element of oxygen and carbon. The nonferrous metal has an affinity with at least one of oxygen and carbon that is greater than such affinity of iron.

In a soft magnetic material with this configuration, the lower film provided between the metal magnetic particle and the insulating upper film is capable of preventing oxygen or carbon included in the inorganic compound in the upper film from diffusing into the metal magnetic particle during the heat treatment of the soft magnetic material since the lower film includes a nonferrous metal with an affinity with oxygen or carbon larger than that of iron in the metal magnetic particle, which promotes the reaction of oxygen and carbon with the nonferrous metal and captures them in the lower film, thereby preventing oxygen and carbon from infiltrating into the metal magnetic particle (gettering effect). This minimizes the increase in the impurity concentration within the metal magnetic particle and thereby prevents degeneration of the metal magnetic particle in its magnetic properties. Preventing oxygen and carbon from diffusing into the metal magnetic particle also minimizes the decrease in the oxygen and carbon contents in the inorganic compound in the upper film, thus preventing decomposition or degradation of the upper film which would result in lower insulation in the upper film.

A soft magnetic material according to another aspect of the present invention includes a plurality of composite magnetic particles. Each of the plurality of composite magnetic particles has: a metal magnetic particle including iron; a lower film surrounding the surface of the metal magnetic particle and including a nonferrous metal; and an insulating upper film surrounding the surface of the lower film and including an inorganic compound. The inorganic compound contains at least any one element of oxygen and carbon. The nonferrous metal has a diffusion coefficient with respect to at least one of oxygen and carbon that is smaller than such diffusion coefficient of iron.

In a soft magnetic material with this configuration, the lower film provided between the insulating upper film and the metal magnetic particle is capable of reducing the diffusion of oxygen or carbon included in the inorganic compound in the upper film into the metal magnetic particle during heat treatment of the soft magnetic material, since the lower film includes a nonferrous metal with a diffusion coefficient with respect to oxygen or carbon smaller than that of iron included in the metal magnetic particle, such that the diffusion rate of oxygen and carbon toward the metal magnetic particle from the upper film is reduced at the lower film, which prevents oxygen and carbon from infiltrating into the metal magnetic particle (barrier effect), which minimizes the increase in impurity concentration in the metal magnetic particle and thus prevents deterioration in magnetic properties of the metal magnetic particle. Preventing oxygen and carbon from diffusing into the metal magnetic particle also minimizes the decrease in the oxygen and carbon content in the inorganic compound in the upper film, thus preventing decomposition or degradation of the upper film, which would result in lower insulation in the upper film.

Thus, these inventions allow performing a heat treatment at high temperatures on a soft magnetic material without causing degeneration of the metal magnetic particle and the insulating upper film.

Preferably, the nonferrous metal includes at least one selected from the group consisting of aluminum (Al), chromium (Cr), silicon (Si), titanium (Ti), vanadium (V), and nickel (Ni). In a soft magnetic material with this configuration, these materials either have large affinity with oxygen or carbon, or have small diffusion coefficient with respect to oxygen or carbon compared with iron. Consequently, the above advantages may be produced by at least one of the gettering effect and the barrier effect from the lower film.

In addition, reaction between these materials and oxygen or carbon may result in increased electric resistance of the lower film, where the lower film may cooperate with the upper film to function as an insulator. Further, these materials do not impair soft magnetic properties of the metal magnetic particle when they form a solid solution with iron included in the metal magnetic particle, preventing deterioration in magnetic properties of the soft magnetic material.

Preferably, the lower film has an average thickness of not less than 50 nm and not more than 1 μm. In a soft magnetic material with this configuration, an average thickness of the lower film not less than 50 nm ensures the gettering or barrier effect from the lower film. Also, since the average thickness of the lower film lies at not more than 1 μm, a molding fabricated using a soft magnetic material of the present invention has no metal magnetic particle too much spaced apart from another. This prevents diamagnetism between metal magnetic particles (energy loss due to magnetic poles in metal magnetic particles), thereby minimizing increased hysteresis loss due to diamagnetism. In addition, the nonmagnetic layer's proportion in volume within the soft magnetic material can be minimized, minimizing the decrease in saturation flux density.

Preferably, the upper film has an average thickness of not less than 10 nm and not more than 1 μm. In a soft magnetic material with this configuration, an average thickness of the upper film not less than 10 nm minimizes tunneling current in the film, thereby minimizing increased eddy current loss due to tunneling current. Further, since the average thickness of the upper film lies at not more than 1 μm, a molding fabricated using a soft magnetic material of the present invention has no metal magnetic particle too much spaced apart from another. This prevents diamagnetism between metal magnetic particles and minimizes increased hysteresis loss due to diamagnetism. Furthermore, the nonmagnetic layer's proportion in volume within the soft magnetic material can be minimized, minimizing the decrease in saturation flux density.

In addition, preferably, the inorganic compound is composed of a compound containing at least one element selected from the group consisting of aluminum, zirconium, titanium, silicon, magnesium, iron, and phosphorus. According to the soft magnetic material with this configuration, as these materials containing at least any one element of oxygen and carbon are excellent in insulation, the eddy current that flows between the metal magnetic particles can further effectively be suppressed.

In addition, preferably, the inorganic compound is at least any one of an inorganic compound generated from a metal alkoxide containing at least one element selected from the group consisting of aluminum, zirconium, titanium, silicon, magnesium, and iron and a phosphorus compound.

According to the soft magnetic material as such, by generating the upper film from the metal alkoxide using an organic solvent, the upper film can be formed of minute and fine particles. Thus, flowability of the soft magnetic material is improved and the metal magnetic particle covered with the upper film is less susceptible to heat.

In addition, the soft magnetic material described above has a rate of change in pressed density less than 5%. According to the soft magnetic material as such, by generating the upper film from the metal alkoxide, flowability of the soft magnetic material can be improved. Therefore, even if forming is performed with low pressure, sufficiently large pressed density can be attained.

In addition, the soft magnetic material described above has a rate of change in a volume resistivity value between before and after heating of at most 20%. According to the soft magnetic material as such, by generating the upper film from the metal alkoxide, the metal magnetic particle covered with the upper film is less susceptible to heat. Therefore, the volume resistivity value after heat treatment of the soft magnetic material can be prevented from significantly lowering from the volume resistivity value before heat treatment.

A method of manufacturing a soft magnetic material according to the present invention is directed to a method of manufacturing the soft magnetic material described above. The method of manufacturing the soft magnetic material includes lower film forming step of forming the lower film on the surface of the metal magnetic particle, and upper film forming step of, subsequent to the lower film forming step, adding a solution of a metal alkoxide to a suspension obtained by dispersing the metal magnetic particles in an organic solvent, air-drying the resultant suspension, and drying resultant powders at a temperature in a range from at least 60° C. to at most 120° C.

According to the method of manufacturing the soft magnetic material with this configuration, the soft magnetic material having excellent flowability during forming and including the metal magnetic particles less susceptible to heat can be fabricated. Here, by setting the drying temperature to at least 60° C., the composite magnetic particles having the upper film formed can sufficiently be dried. Thus, in fabricating the molding using the soft magnetic material according to the present invention, compressibility of the soft magnetic material can be ensured and a high-density molding can be obtained. In addition, by setting the drying temperature to 120° C. or lower, generation of rust on the surface of the metal magnetic particles can be prevented. Thus, deterioration of the magnetic property of the soft magnetic material can be prevented.

In addition, preferably, the upper film forming step includes the step of further adding a phosphoric acid solution to the suspension to which the solution of the metal alkoxide has been added. According to the method of manufacturing the soft magnetic material as such, compressibility, flowability and a rate of change in an electric resistance value after burning at a high temperature can further effectively be improved.

A dust core according to the present invention is fabricated using any of the soft magnetic materials described above. In a dust core with this configuration, heat treatment at high temperatures achieves satisfactory reduction in distortion within the dust core, thereby providing improved magnetic properties in that the hysteresis loss is reduced. At the same time, despite the heat treatment at high temperatures, the insulating upper film protected by virtue of the lower film may provide improved magnetic properties in that the eddy current loss is reduced.

Preferably, the dust core further includes an organic matter disposed between the plurality of composite magnetic particles to join the plurality of composite magnetic particles together and including at least one selected from the group consisting of a polyethylene resin, a silicone resin, a polyamide resin, a polyimide resin, a polyamide imide resin, an epoxy resin, a phenolic resin, an acrylic resin, and a polytetrafluoroethylene.

In a soft magnetic material with this configuration, these organic matters firmly join the plurality of composite magnetic particles together and function as a lubricant during the pressure-forming of the soft magnetic material, thereby preventing the composite magnetic particles from rubbing against each other which would otherwise damage the upper film. Thus, the strength of the dust core may be improved and the eddy current loss may be reduced. Further, since the metal magnetic particle is covered with the lower film, oxygen or carbon included in these organic matters can be prevented from diffusing into the metal magnetic particle.

A method of manufacturing the dust core according to the present invention is directed to a method of manufacturing a dust core described above. The method of manufacturing the dust core includes the steps of: by pressure-forming the plurality of composite magnetic particles, forming a molding; and heat-treating the molding at a temperature of not less than 500° C.

In a method of manufacturing a dust core with this configuration, a temperature for the heat treatment performed on the molding not less than 500° C. can reduce distortion within the dust core to a satisfactory degree. Further, despite the fact that the molding may be exposed to such high temperatures, the lower film may act to prevent degeneration of the metal magnetic particle and the insulating upper film.

### EFFECTS OF THE INVENTION

As described above, the present invention may provide a soft magnetic material providing desirable magnetic properties, a method of manufacturing a soft magnetic material, a dust core, and a method of manufacturing a dust core.

### BRIEF DESCRIPTION OF THE DRAWINGS

FIG. 1 is a schematic cross section of a dust core fabricated using a soft magnetic material in an embodiment of the present invention.

FIG. 2 is an enlarged schematic view showing the area defined by the phantom line II in FIG. 1, where the lower film is formed of a nonferrous metal with an affinity with oxygen or carbon larger than that of iron.

FIG. 3 is an enlarged schematic view showing the area defined by the phantom line II in FIG. 1, where the lower film is formed of a nonferrous metal with a diffusion coefficient with respect to oxygen or carbon smaller than that of iron.

FIG. 4 is a graph showing the crystalline magnetic anisotropy of iron with which various metals form a solid solution versus the content of the metals in the solid solution.

### DESCRIPTION OF THE REFERENCE CHARACTERS

10 metal magnetic particle, 20 lower film, 30 upper film, 40 composite magnetic particle, 50 organic matter

### BEST MODES FOR CARRYING OUT THE INVENTION

Embodiments of the present invention will now be described with reference to the drawings.

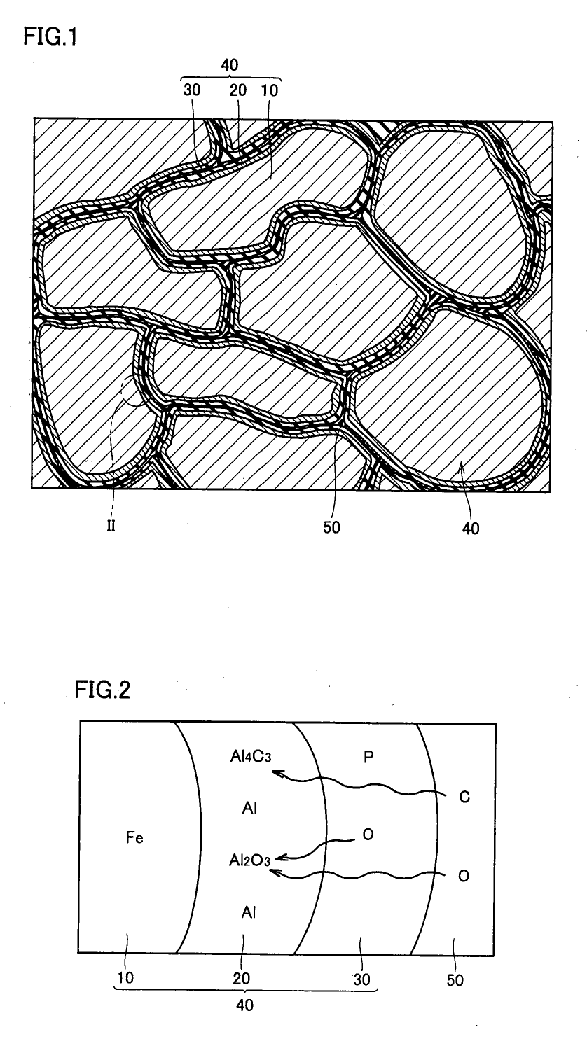

FIG. 1 is a schematic cross section of a dust core fabricated using a soft magnetic material in an embodiment of the present invention. Referring to FIG. 1, a soft magnetic material includes a plurality of composite magnetic particles 40 each including a metal magnetic particle 10, a lower film 20 surrounding a surface of metal magnetic particle 10 and an upper film 30 surrounding a surface of lower film 20. An organic matter 50 is disposed between composite magnetic particles 40, which is formed of, for example, a polyethylene resin, a silicone resin, a polyamide resin, a polyimide resin, a polyamide imide resin, an epoxy resin, a phenolic resin, an acrylic resin, and a polytetrafluoroethylene (Teflon®). A dust core is formed by composite magnetic particles 40 joined together by the engagement of protrusions and recesses on composite magnetic particles 40 or joined together by organic matter 50.

It should be noted that organic matter 50 is not necessarily provided in the present invention, and composite magnetic particles 40 may only be joined together by the engagement of protrusions and recesses on composite magnetic particles 40.

Metal magnetic particle 10 includes iron (Fe) and is made of, for example, iron (Fe), iron (Fe)-silicon (Si) based alloys, iron (Fe)-nitrogen (N) based alloys, iron (Fe)-nickel (Ni) based alloys, iron (Fe)-carbon (C) based alloys, iron (Fe)-boron (B) based alloys, iron (Fe)-cobalt (Co) based alloys, iron (Fe)-phosphorus (P) based alloys, iron (Fe)-chromium (Cr) based alloys, iron (Fe)-nickel (Ni)-cobalt (Co) based alloys, iron (Fe)-aluminum (Al)-silicon (Si) based alloys, ferrite, or the like with various manufacturing methods, such as atomized iron powders, reduced iron powders and carbonyl iron powders. Metal magnetic particle 10 may be made of iron only or an iron-based alloy.

Metal magnetic particle 10 preferably has an average size of not less than 5 μm and not more than 300 μm. An average size of metal magnetic particle 10 of not less than 5 μm reduces the likelihood of metal magnetic particle 10 being oxidized, thereby providing improved magnetic properties of the dust core. An average size of metal magnetic particle 10 of not more than 300 μm avoids a decrease in compressibility of powders during the pressure-forming. Thus, the density of the molding provided by the pressure-forming can be increased.

The average size used herein means the particle size at which the sum of the masses of the particles of smaller size in a histogram of particle size measured by screening method reaches 50% of the total mass, i.e., 50% particle size D.

Lower film 20 includes a nonferrous metal such as aluminum, chromium, silicon, titanium, vanadium, or nickel. Table 1 shows the affinity of nonferrous metals forming lower film 20 with carbon and oxygen as well as the affinity of iron with carbon and oxygen. Table 1 shows primary compounds produced by the reaction between these metals and carbon and oxygen as well as the heat generated during the reaction, where greater absolute values of heat generated indicate greater affinities with carbon or oxygen.

TABLE 1

| | Affinity with Carbon | | Affinity with Oxygen | |
|---|---|---|---|---|
| | | Generated Heat | | Generated Heat |
| | Primary | (@25° C.) | Primary | (@25° C.) |
| Metal | Compound | (kJ/mol) | Compound | (kJ/mol) |
| Al | Al₄C₃ | −3675 | Al₂O₃ | −1677 |
| Cr | Cr₃C₂ | −2721 | Cr₂O₃ | −1129 |
| Ni | none | — | NiO | −241 |
| Si | SiC | −1240 | SiO₂ | −910 |
| Ti | TiC | −5900 | TiO | −805 |
| V | VC | −1245 | V₂O₃ | −1219 |
| Fe | Fe₃C | −1109 | FeO | −264 |

Referring to Table 1, it can be seen that the affinities of aluminum, chromium, silicon, titanium, and vanadium with carbon and oxygen are greater than the affinity of iron with carbon and oxygen. While there is no carbide for nickel, its affinity with oxygen lies at the same level with the affinity of iron with oxygen.

Table 2 shows the diffusion coefficient of nonferrous metals forming lower film 20 with respect to carbon and oxygen as well as the diffusion coefficient of iron with respect to carbon and oxygen. The diffusion frequency coefficient Do and the diffusion activation energy Q in Table 2 are measured at temperatures ranging from about 500° C. to 900° C., and the diffusion coefficient D and the diffusion distance L are measured at a temperature of 600° C.

TABLE 2

| | C Diffusion Coefficient in Metal | | | | O Diffusion Coefficient in Metal | | | |
|---|---|---|---|---|---|---|---|---|
| | Do | Q | D(@600° C.) | L(@600° C.) | Do | Q | D(@600° C.) | L(@600° C.) |
| Metal | (m²/s) | (kJ/mol) | (m²/s) | (μm) | (m²/s) | (kJ/mol) | (m²/s) | (μm) |
| Al | — | — | — | — | — | — | — | — |
| Cr | 9.00 × 10⁻⁷ | 111 | 2.06 × 10⁻¹³ | 7.7 | — | — | — | — |
| Ni | 1.20 × 10⁻⁵ | 142 | 3.83 × 10⁻¹⁴ | 3.3 | 5.80 × 10⁻⁴ | 292 | 1.97 × 10⁻²¹ | 0.00075 |
| Si | 1.90 × 10⁻⁴ | 13 | 3.17 × 10⁻⁵ | 9.5 × 10⁻⁴ | 2.10 × 10⁻⁵ | 241 | 8.01 × 10⁻²⁰ | 0.0048 |
| Ti | 7.90 × 10⁻⁸ | 128 | 1.74 × 10⁻¹⁵ | 0.71 | 5.10 × 10⁻⁷ | 140 | 2.15 × 10⁻¹⁵ | 0.78 |
| V | 4.90 × 10⁻⁷ | 114 | 7.41 × 10⁻¹⁴ | 4.6 | 1.10 × 10⁻⁵ | 121 | 6.34 × 10⁻¹³ | 13 |
| Fe | 1.24 × 10⁻⁵ | 96 | 2.24 × 10⁻¹¹ | 80 | 1.00 × 10⁻⁵ | 111 | 2.29 × 10⁻¹² | 26 |

Do: Diffusion frequency term
Q: Diffusion activation energy
D (Diffusion coefficient): Do × exp(−Q/RT): R gas constant = 8.315 [J/mol/K], T temperature [K]
L: Diffusion distance (the diffusion time being one hour, the interface between the diffusion source and the portion into which diffusion occurs being assumed to be spherical)

Referring to Table 2, it can be seen that the diffusion coefficients of chromium, nickel, titanium, and vanadium with respect to carbon are smaller than the diffusion coefficient of iron with respect to carbon. It can also be seen that the diffusion coefficients of nickel, silicon, titanium, and vanadium with respect to oxygen are smaller than the diffusion coefficient of iron with respect to oxygen. Accordingly, lower film 20 is formed of a nonferrous metal with large affinity with carbon or oxygen, a nonferrous metal with small diffusion coefficient with respect to carbon or oxygen, or a nonferrous metal with large affinity with carbon or oxygen and with small diffusion coefficient with respect to carbon and oxygen compared with iron.

Lower film 20 preferably has an average thickness of not less than 50 nm and not more than 1 μm. The average thickness used herein means the estimated thickness derived from the film composition provided by composition analysis (transmission electron microscope energy dispersive X-ray spectroscopy (TEM-EDX)) and the element weight provided by inductively coupled plasma-mass spectrometry (ICP-MS), after which the film is observed directly on a TEM picture to confirm the order of the derived estimated thickness.

Upper film 30 has electric insulation, and it is formed from at least any one of an inorganic compound generated from a metal alkoxide containing at least one element selected from the group consisting of aluminum, zirconium, titanium, silicon, magnesium, and iron and a phosphorus compound. The inorganic compound or the phosphorus compound contains at least any one element of oxygen and carbon.

If upper film 30 is generated from the metal alkoxide, an organic compound composing the metal alkoxide is removed as alcohol and a metal oxide remains. Depending on a condition at the time of generation, however, carbon may partially remain in the metal oxide. By generating upper film 30 from the metal alkoxide, generation of salt such as sodium salt or calcium salt and hence resultant greater electric conductivity of upper film 30 is not likely, as in the case of generation of upper film 30 from an aqueous solution. Therefore, in the present embodiment, an effect to suppress lowering in insulation of upper film 30 can be obtained.

A coating amount of the inorganic compound generated from the metal alkoxide is preferably set to at least 0.001 mass % to at most 100 mass %, in conversion into element of each metal. If the coating amount is less than 0.001 mass %, the effect of the present invention is not obtained. As the effect of the present invention is sufficiently obtained by setting an amount of addition in a range from at least 0.001 mass % to at most 100 mass %, addition in an amount exceeding 100 mass % more than necessary is useless. Considering compressibility and flowability of the soft magnetic material that is obtained, an amount in a range from at least 0.002 mass % to at most 75 mass % is more preferred and an amount in a range from at least 0.003 mass % to at most 50 mass % is further preferred.

The coating amount of the phosphorous compound is preferably set to a value in a range from at least 0.001 mass % to at most 100 mass %, in conversion into P. If the coating amount is less than 0.001 mass %, the effect of the present invention is not obtained. As the effect of the present invention is sufficiently obtained by setting an amount of addition in a range from at least 0.001 mass % to at most 100 mass %, addition in an amount exceeding 100 mass % more than necessary is useless. Considering compressibility and flowability of the soft magnetic material that is obtained as well as packing fraction of metal magnetic particles 10 when used for the dust core, an amount in a range from at least 0.002 mass % to at most 75 mass % is more preferred and an amount in a range from at least 0.003 mass % to at most 50 mass % is further preferred.

As to compressibility of the soft magnetic material in the present embodiment, the rate of change in pressed density found by using an evaluation method which will be described later is preferably less than 5%. If the rate of change in pressed density is 5% or greater, high pressure is required in fabricating the dust core, which is not preferred. The pressed density of the soft magnetic material is more preferably at most 4% and further preferably at most 3%.

The soft magnetic material in the present embodiment preferably has the volume resistivity value of at least 1.0 mΩ·cm, and more preferably at least 2.0 mΩ·cm. In addition, the rate of change in the volume resistivity value between before and after heating at a temperature of 500° C. for 1 hour is preferably at most 20%, more preferably at most 15%, and further preferably at most 10%. If the rate of change in the volume resistivity value between before and after heating exceeds 20%, a specific resistance value of the dust core obtained by using the soft magnetic material tends to lower during annealing, which is not preferred.

The soft magnetic material in the present embodiment preferably has flowability at flowability index of at least 70. If the flowability index is smaller than 70, packing characteristic into the mold is not sufficient in fabricating the dust core, and the packing fraction of metal magnetic particles 10 composing the dust core is lowered. More preferably, the flowability index is in a range from at least 75 to at most 95.

Upper film 30 preferably has an average thickness in a range from at least 10 nm to at most 1 μm. The average thickness herein is also determined by using the method the same as that described above.

Upper film 30 functions as an insulator between metal magnetic particles 10. By covering metal magnetic particle 10 with upper film 30, the specific resistance value of the dust core can be made larger. This minimizes the eddy current between metal magnetic particles 10 and thereby reducing the iron loss of the dust core due to eddy current loss.

A soft magnetic material in an embodiment of the present invention includes a plurality of composite magnetic particles 40. Each of composite magnetic particles 40 includes: a metal magnetic particle 10 including iron; a lower film 20 surrounding a surface of metal magnetic particle 10 and including a nonferrous metal; and an insulating upper film 30 surrounding a surface of lower film 20 and including an inorganic compound. The inorganic compound contains at least any one element of oxygen and carbon. The nonferrous metal has an affinity with at least one of oxygen and carbon that is greater than such affinity of iron. The nonferrous metal has a diffusion coefficient with respect to at least one of oxygen and carbon that is smaller than such diffusion coefficient of iron.

A method of manufacturing the dust core shown in FIG. 1 will now be described. Initially, lower film 20 is formed on the surface of metal magnetic particle 10. Examples of the method of forming lower film 20 include vacuum deposition, plating, sol-gel process, or Bonde process.

Thereafter, a solution of the metal alkoxide is added to a suspension obtained by dispersing metal magnetic particles 10 having lower film 20 formed in a water-soluble organic solvent. In some cases, a phosphoric acid aqueous solution is further added. The suspension to which the solution has been added is air-dried, and thereafter dried at a temperature in a range from at least 60° C. to at most 120° C.

In the present embodiment, metal magnetic particle 10, which is a starting material, has the rate of change in pressed density of at least 5%, which is found using an evaluation method which will be described later.

In the present embodiment, metal magnetic particle 10, which is a starting material, normally has the volume resistivity value preferably of at least 0.1 mΩ·cm, and more preferably of at least 0.5 mΩ·cm. In addition, the rate of change in the volume resistivity value between before and after heating at a temperature of 500° C. for 1 hour is normally at least 25%.

In the present embodiment, metal magnetic particle 10, which is a starting material, normally has flowability at flowability index of at least 50, and preferably has flowability at flowability index in a range from at least 50 to at most 80.

The organic solvent in which metal magnetic particles 10 having lower film 20 formed are dispersed is not limited, provided that it is a generally-used organic solvent, however, a water-soluble organic solvent is preferably used. Specifically, an alcohol-based solvent such as ethyl alcohol, propyl alcohol, butyl alcohol, or the like; a ketone-based solvent such as acetone, methyl ethyl ketone or the like; a glycol-ether-based solvent such as methyl cellosolve, ethyl cellosolve, propyl cellosolve, butyl cellosolve, or the like; oxyethylene such as diethylene glycol, triethylene glycol, polyethylene glycol, dipropylene glycol or tripropylene glycol, polypropylene glycol, or the like; an oxypropylene addition polymer; alkylene glycol such as ethylene glycol, propylene glycol, 1,2,6-hexanetriol, or the like; glycerol; 2-pyrrolidone; or the like may suitably be used as the organic solvent. More preferably, an alcohol-based solvent such as ethyl alcohol, propyl alcohol, butyl alcohol, or the like, or a ketone-based solvent such as acetone, methyl ethyl ketone or the like is used.

Aluminum, zirconium, titanium, silicon, magnesium, iron, or the like may be used as a metal element composing the metal alkoxide. In addition, the type of the alkoxide includes methoxide, ethoxide, propoxide, isopropoxide, oxyisopropoxide, butoxide, or the like. Considering uniformity in treatment and an effect of the treatment, tetraethoxysilane, aluminum triisopropoxide, zirconium tetraisopropoxide, titanium tetraisopropoxide, or the like is preferably used.

In addition, for more uniform treatment, the metal alkoxide in a state dispersed or dissolved in the organic solvent above in advance is preferably used.

Moreover, as to hydrolysis of the metal alkoxide, in order to adhere finer inorganic compounds onto the surface of lower film 20 formed on the surface of metal magnetic particle 10, or to coat the surface of lower film 20 formed on the surface of metal magnetic particle 10 with finer inorganic compounds, it is not particularly necessary to add moisture. Preferably, hydrolysis is carried out using moisture in the organic solvent and moisture in metal magnetic particle 10 and lower film 20.

Though different depending on a specific surface area of the metal magnetic particle, an amount of addition of the metal alkoxide is normally set in a range from at least 0.001 part by mass to 100 parts by mass in conversion into each element, per 100 parts by mass of metal magnetic particles 10. If the amount of addition is smaller than 0.001 part by mass, the effect of the present invention is not obtained. As the effect of the present invention is sufficiently obtained by setting an amount of addition in a range from at least 0.001 part by mass to at most 100 parts by mass, addition in an amount exceeding 100 parts by mass more than necessary is useless. Considering compressibility and flowability of the soft magnetic material that is obtained, an amount in a range from at least 0.002 part by mass to at most 75 parts by mass is more preferred and an amount in a range from at least 0.003 part by mass to at most 50 parts by mass is further preferred.

The phosphoric acid solution or the phosphate solution may be added to the suspension, instead of the metal alkoxide, however, preferably, the phosphoric acid solution or the phosphate solution is further added to the suspension to which the solution of the metal alkoxide has been added.

Though different depending on a specific surface area of the metal magnetic particle, the amount of addition of phosphoric acid or phosphate is preferably set in a range from at least 0.001 part by mass to at most 100 parts by mass in conversion into P, per 100 parts by mass of metal magnetic particles 10. If the amount of addition is less than 0.001 part by mass, the effect of the present invention is not obtained. As the effect of the present invention is sufficiently obtained by setting an amount of addition in a range from at least 0.001 part by mass to at most 100 parts by mass, addition in an amount exceeding 100 parts by mass more than necessary is useless. Considering compressibility and flowability of the soft magnetic material that is obtained as well as packing fraction of metal magnetic particles 10 when used for the dust core, an amount in a range from at least 0.002 part by mass to at most 75 parts by mass is more preferred and an amount in a range from at least 0.003 part by mass to at most 50 parts by mass is further preferred.

Examples of equipment for mixing metal magnetic particles 10 having lower film 20 formed with the metal alkoxide solution and/or the phosphoric acid or phosphate solution include a high-speed agitation type mixer, more specifically a Henschel mixer, a speed mixer, a ball cutter, a power mixer, a hybrid mixer, a cone blender, and the like.

If phosphoric acid or phosphate is added as an aqueous solution, in order to prevent abrupt progress of hydrolysis, preferably, it is added little by little.

The resultant powders are dried at room temperature in a draft for a time period in a range from at least 3 hours to at most 24 hours, and thereafter, dried at a temperature in a range from at least 60° C. to at most 120° C. for a time period in a range from at least 1 hour to at most 24 hours.

Through the steps above, composite magnetic particles 40 in which the surface of metal magnetic particle 10 is successively covered with lower film 20 and upper film 30 are fabricated. Thereafter, composite magnetic particles 40 and organic matter 50 are placed in the mold, and subjected to pressure-forming, for example, at a pressure in a range from 700 MPa to 1500 MPa. Then, composite magnetic particles 40 are compressed, thus obtaining the molding. Pressure-forming may be performed in atmosphere, however, an inert gas atmosphere or a reduced-pressure atmosphere is preferably adopted. Then, oxidation of composite magnetic particles 40 due to oxygen in atmosphere can be suppressed.

Here, organic matter 50 is located between adjacent composite magnetic particles 40 and prevents upper films 30 provided on their respective composite magnetic particles 40 from rubbing against each other. Thus, upper film 30 is not damaged during the pressure-forming.

The molding provided by the pressure-forming is then heat-treated at a temperature of not less than 500° C. and not more than 900° C. in order to remove distortions or dislocations within the molding. During the heat treatment, lower film 20 formed between metal magnetic particle 10 and upper film 30 acts to prevent oxygen and carbon included in upper film 30 or organic matter 50 from diffusing into metal magnetic particle 10. In this regard, description will be made separately of a lower film 20 formed of a material including a nonferrous metal with large affinity with oxygen or carbon and of a lower film 20 formed of a material including a nonferrous metal with small diffusion coefficient with respect to oxygen or carbon compared with iron.

FIG. 2 is an enlarged schematic view showing the area defined by the phantom line II in FIG. 1, where the lower film is formed of a nonferrous metal with an affinity with oxygen or carbon larger than that of iron.

Referring to FIG. 2, the drawing assumes that lower film 20 is formed of aluminum and upper film 30 is formed of a phosphoric acid compound. Here, oxygen included in upper film 30 and organic matter 50 and carbon included in organic matter 50 diffuse to lower film 20 and toward metal magnetic particle 10 during the heat treatment of the molding. However, since lower film 20 is made of aluminum, which has an affinity with oxygen and carbon larger than that of iron, lower film 20 promotes the reaction of aluminum with oxygen and carbon, incessantly generating reaction product i.e. Al₂O₃ and Al₄C₃, which prevents oxygen and carbon from infiltrating into metal magnetic particle 10.

In addition, aluminum, chromium and silicon oxides have increased electric resistance over metal alone, such that lower film 20, in addition to upper film 30, may function as an insulator between metal magnetic particles 10 after the heat treatment. Even when some nonferrous metal exists in the form of an oxide, the gettering effect can be obtained when the amount of oxygen is not more than that of the stoichiometric composition. Thus, increased electric resistance can be achieved by the production of oxide by arranging for the lower film to be an oxide of a nonferrous metal satisfying the composition range where oxygen is less than that of the stoichiometric composition. Its examples include amorphous materials such as amorphous nonferrous metals (Al, Cr, Si)-oxygen (O), amorphous nonferrous metals (Al, Cr, Si)-phosphorus (P)-oxygen (O), and amorphous nonferrous metals (Al, Cr, Si)-boron (B)-oxygen (O).

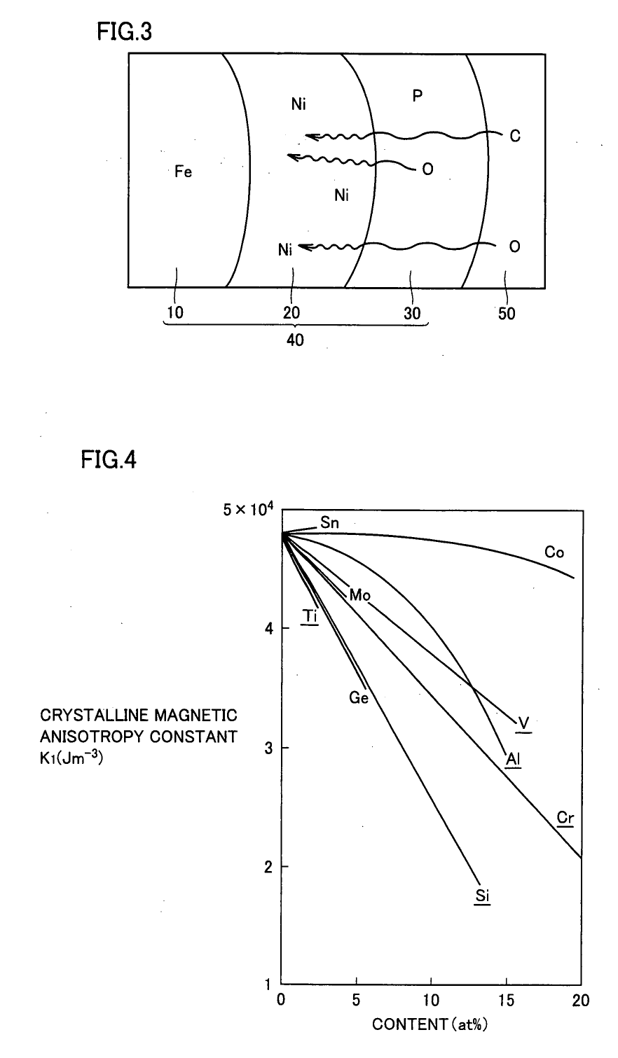

FIG. 3 is an enlarged schematic view showing the area defined by the phantom line II in FIG. 1, where the lower film is formed of a nonferrous metal with a diffusion coefficient with respect to oxygen or carbon smaller than that of iron.

Referring to FIG. 3, the drawing assumes that lower film 20 and upper film 30 are formed of nickel and a phosphoric acid compound, respectively. Here, lower film 20 is formed of nickel which has a diffusion coefficient with respect to oxygen or carbon smaller than that of iron, which reduces the diffusion rate of oxygen and carbon in lower film 20 thereby preventing oxygen and carbon from infiltrating into metal magnetic particle 10.

Although the functions of lower film 20 have been separately described referring to FIGS. 2 and 3 for convenience, lower film 20 may be formed of a nonferrous metal with large affinity with carbon or oxygen and with small diffusion coefficient with respect to carbon or oxygen compared with iron, where lower film 20 exhibits the both functions described referring to FIGS. 2 and 3, which further ensures that oxygen and carbon are prevented from infiltrating into metal magnetic particle 10.

Nonferrous metals forming lower film 20 such as aluminum, chromium, silicon, titanium, vanadium, and nickel may react with iron within metal magnetic particle 10 without impairing soft magnetic properties of metal magnetic particle 10. FIG. 4 is a graph showing the crystalline magnetic anisotropy of iron with which various metals, form a solid solution versus the content of the metals in the solid solution. Referring to FIG. 4, the crystalline magnetic anisotropy decreases as the content of aluminum or other metals increases. This demonstrates that a nonferrous metal forming lower film 20 may react with iron resulting in an alloyed metal magnetic particle 10 without impairing soft magnetic properties of metal magnetic particle 10.

After the heat treatment, the molding undergoes an appropriate treatment such as extrusion or cutting to provide a finished dust core as shown in FIG. 1.

The volume fraction (vol %) of metal magnetic particles 10 in the resultant dust core is at least 90%, preferably 91%, and more preferably at least 92%.

The dust core has a specific resistance value of at least 2.0 mΩ·cm, preferably at least 3.0 mΩ·cm, and more preferably at least 4.0 mΩ·cm. In addition, the dust core has the rate of change in the specific resistance value between before and after the heat treatment is preferably at most 20%, more preferably at most 15%, and further preferably at most 10%.

A soft magnetic material with this configuration and a dust core fabricated using such soft magnetic material may reduce diffusion of oxygen and carbon into metal magnetic particle 10 despite heat treatment at a high temperature of not less than 500° C. Consequently, the concentration of oxygen and carbon included in upper film 30 does not dramatically decrease, such that the insulation in upper film 30 is maintained. In this way, upper film 30 ensures insulation between metal magnetic particles 10, thereby reducing the eddy current loss of the dust core.

Meanwhile, heat treatment at high temperatures achieves a satisfactory reduction of distortion within the dust core. Moreover, since diffusion of oxygen and carbon into metal magnetic particle 10 is minimized, the concentration of impurities in metal magnetic particle 10 does not increase. Thus, the hysteresis loss of the dust core can be decreased to a satisfactory level. Thus, a dust core may be achieved that provides low iron loss in wide frequency range.

Further, upper film 30 is formed of a metal alkoxide with the use of an organic solvent, so that very fine protrusions can be produced on the surface of composite magnetic particle 40. Thus, as flowability of composite magnetic particles 40 during pressure-forming thereof is improved, the molding with high packing fraction can be obtained. Namely, even if the pressure during pressure-forming is low, density of the molding can sufficiently be high.

In addition, upper film 30 generated from the metal alkoxide with the use of the organic solvent is composed of minute and fine particles. Therefore, metal magnetic particles 10 covered with upper film 30 are less susceptible to heat. Thus, the soft magnetic material smaller in the rate of decrease in the volume resistivity value despite exposure to high temperature can be obtained. By fabricating the molding using such a soft magnetic material, even if the temperature for heat treatment is high, the specific resistance value of the molding after heat treatment can be maintained substantially as high as that before heat treatment.

### EXAMPLES

A soft magnetic material of the present invention was evaluated in the examples provided below.

### Example 1

Atomized pure iron powders commercially available from Hoeganaes Corporation (product name “ABC100.30”, purity 99.8% or more) were first procured for metal magnetic particles 10. Lower film 20 with an average thickness of 100 nm was then formed upon metal magnetic particles 10 using vacuum deposition, plating, sol-gel method, or Bonde process, and upper film 30 with an average thickness of 100 nm was then formed using sol-gel method or Bonde process to provide powders, i.e., composite magnetic particles 40. Aluminum, chromium, nickel, silicon, and amorphous aluminum-phosphorus-oxygen were used for lower film 20, while an Si glass (Si—O compound) representing the inorganic compound was used for upper film 30. For comparison, powders with only upper film 30 without lower film 20 were also prepared.

Separately, metal magnetic particles 10 having an aluminum film formed as lower film 20 described above were introduced in acetone and they encountered each other by means of an agitator, thereby obtaining slurry of acetone. An acetone solution in which aluminum isopropoxide was dispersed was added to the slurry, and the resultant solution was stirred and mixed. Thereafter, a phosphoric acid aqueous solution was added to the mixture solution, and the resultant solution was further stirred and mixed. The resultant mixture solution was air-dried in the draft, and thereafter dried at a temperature of 80° C. using a drier. Through the steps above, powders of composite magnetic particles 40, in which an inorganic compound having an average thickness of 100 nm and containing Al and P was formed as upper film 30 composed of inorganic compound generated from a metal alkoxide, were completed. In addition, for comparison, powders not with lower film 20 but solely with an inorganic compound containing Al and P and serving as upper film 30 were also prepared.

Organic matter 50, i.e., a polyphenylene sulfide (PPS) resin, was then added in a proportion of 0.1 mass % to the powders and the resulting mixed powders were pressure-formed at a surface pressure of 1275 MPa(=13 ton/cm²) to form a molding. The molding was then heat-treated in a nitrogen atmosphere for one hour at different temperatures ranging from 300° C. to 900° C. From these steps, several dust core materials were fabricated with different types of lower film and upper film.

A coil was then wound uniformly around the fabricated dust core materials (300 turns for the primary and 20 turns for the secondary), and magnetic properties of the dust core materials were evaluated. The evaluation employed a BH tracer from RikenDenshi Co., Ltd. (ACBH-100K) and used an excitation flux density of 10 kG (kilogauss) and a measurement frequency of 1000 Hz. Tables 3 and 4 show the hysteresis loss coefficient Kh, the eddy current loss coefficient Ke, and the iron loss W_{10/1000} for each dust core material from the measurements: Table 3 shows results in a case where Si glass was used for upper film 30, and Table 4 shows results in a case where the inorganic compound containing Al and P was used for upper film 30.

The iron loss value W is given by the sum of the hysteresis loss and the eddy current loss, and determined by the following equation based on the hysteresis loss coefficient Kh, eddy current loss coefficient Ke, and frequency f:

W=Kh×f+Ke×f²

The smaller the coercivity Hc i.e., the better the soft magnetic properties, the smaller the hysteresis loss coefficient Kh becomes. The better the insulation between particles and the greater the total resistance in the dust core, the smaller the eddy current loss coefficient Ke becomes. That is, the lower the coercivity and the higher the resistance, the smaller the hysteresis loss coefficient Kh and eddy current loss coefficient Ke become, which means smaller hysteresis loss and eddy current loss, resulting in a smaller iron loss. In general, the higher the temperature at which the dust core is heat-treated, the larger the amount of decrease in distortion becomes, which leads to a decrease in the coercivity Hc and hysteresis loss coefficient Kh. However, heat treatment at high temperature may deteriorate the insulation film, resulting in an unsatisfactory insulation between particles, where some magnetic particles act as one particle with large size with respect to the skin depth. In this case, the surface current due to the skin effect is significant, and both hysteresis loss and eddy current loss dramatically increase. When derived from the iron loss in such conditions using the above equation, both the hysteresis loss coefficient Kh and eddy current loss coefficient Ke will significantly increase, which in the present embodiment corresponds to the case where heat treatment was conducted at temperatures above the upper limit temperatures in the tables below.

TABLE 3

| | Upper Film | | | | | | | | |
|---|---|---|---|---|---|---|---|---|---|
| | Si glass/Average Thickness 100 nm | | | | | | | | |
| | Lower Film | | | | | | | | |
| Heat | Al/Average | | | Cr/Average Thickness | | | Ni/Average Thickness | | |
| Treatment | Thickness 100 nm | | | 100 nm | | | 100 nm | | |
| Temperature | Kh | Ke | W_{10/1000} | Kh | Ke | W_{10/1000} | Kh | Ke | W_{10/1000} |
| 300° C. | 142 | 0.036 | 178 | 150 | 0.039 | 189 | 149 | 0.034 | 183 |
| 400° C. | 130 | 0.034 | 164 | 133 | 0.040 | 173 | 129 | 0.036 | 165 |
| 500° C. | 102 | 0.045 | 147 | 106 | 0.055 | 161 | 101 | 0.041 | 142 |
| 600° C. | 71 | 0.050 | 121 | 80 | 0.081 | 161 | 73 | 0.052 | 125 |
| 700° C. | 77 | 0.163 | 240 | 88 | 0.226 | 314 | 68 | 0.069 | 137 |
| 800° C. | 95 | 0.254 | 349 | 120 | 0.369 | 489 | 71 | 0.088 | 159 |
| 900° C. | 133 | 0.460 | 593 | 169 | 0.690 | 859 | 79 | 0.142 | 221 |
| | Upper Film | | | | | | | | |
| | Si glass/Average Thickness 100 nm | | | | | | | | |
| | Lower Film | | | | | | | | |
| Heat | Si/Average Thickness | | | Al—P—O/Average | | | | | |
| Treatment | 100 nm | | | Thickness 100 mn | | | not provided | | |
| Temperature | Kh | Ke | W_{10/1000} | Kh | Ke | W_{10/1000} | Kh | Ke | W_{10/1000} |
| 300° C. | 144 | 0.030 | 174 | 144 | 0.025 | 169 | 142 | 0.033 | 175 |
| 400° C. | 131 | 0.042 | 173 | 130 | 0.027 | 157 | 131 | 0.046 | 177 |
| 500° C. | 93 | 0.066 | 159 | 91 | 0.033 | 124 | 106 | 0.092 | 198 |
| 600° C. | 77 | 0.097 | 174 | 132 | 0.198 | 330 | 89 | 0.183 | 272 |
| 700° C. | 103 | 0.356 | 459 | 202 | 0.582 | 784 | 104 | 0.556 | 660 |
| 800° C. | 169 | 0.854 | 1023 | 226 | 1.322 | 1548 | 136 | 1.842 | 978 |

| | | | | | |
|---|---|---|---|---|---|
| 900° C. | 229 | 1.511 | 1740 | not available | not available |

Unit: Kh [mWs/kg], Ke [mWs²/kg], W_{10/1000} [W/kg]

TABLE 4

| | Upper Film | | | | | |
|---|---|---|---|---|---|---|
| | Inorganic Compound Containing Al | | | | | |
| | and P/Average Thickness 100 nm | | | | | |
| | Lower Film | | | | | |
| Heat | Al/Average Thickness | | | | | |
| Treatment | 100 nm | | | not provided | | |
| Temperature | Kh | Ke | W_{10/1000} | Kh | Ke | W_{10/1000} |
| 300° C. | 143 | 0.036 | 179 | 143 | 0.037 | 180 |
| 400° C. | 131 | 0.027 | 158 | 130 | 0.039 | 169 |
| 500° C. | 97 | 0.032 | 129 | 99 | 0.073 | 172 |
| 600° C. | 130 | 0.210 | 340 | 153 | 0.258 | 411 |
| 700° C. | 205 | 0.675 | 880 | 238 | 0.829 | 1067 |
| 800° C. | 221 | 1.918 | 2139 | 275 | 2.021 | 2296 |

| | | |
|---|---|---|
| 900° C. | not available | not available |

Unit: Kh [mWs/kg], Ke [mWs²/kg], W_{10/1000} [W/kg]

Referring to Table 3 where Si glass was used for upper film 30, the dust core materials without lower film 20 exhibited increased eddy current loss coefficients at the heat treatment temperatures of 400° C. and above, while the dust core materials with aluminum, chromium and nickel as lower film 20 had an upper limit temperature of 600° C. at which the eddy current loss coefficient begins to increase, and the dust core material with silicon as lower film 20 had an upper limit temperature of 500° C. The dust core material with amorphous aluminum-phosphorus-oxygen as lower film 20 had an upper limit temperature of 500° C. In this way, heat treatment at 500° C. or higher was possible, and as a result, each lower film 20 produced the lowest value of iron loss at its upper limit temperature. For each film, such value of iron loss was smaller than the lowest iron loss of the material without lower film 20, i.e., 175 W/kg. Results similar to above were obtained, also as shown in Table 4 using the inorganic compound containing Al and P for upper film 30.

Further, dust core materials were fabricated under the similar conditions as above, by using aluminum, chromium, nickel, and silicon for lower film 20, with average thicknesses of lower film 20 of 500 nm and 1000 nm. Magnetic properties of these dust core materials were also evaluated. Tables 5 and 6 show the hysteresis loss coefficient Kh, the eddy current loss coefficient Ke and iron loss W_{10/1000} for each dust core material. The results shown in Table 5 represent values when the average thickness of lower film 20 was set to 500 nm, and the results shown in Table 6 represent values when the average thickness of lower film 20 was set to 1000 nm.

TABLE 5

| | Upper Film | | | | | | | | | | | |
|---|---|---|---|---|---|---|---|---|---|---|---|---|
| | Si glass/Average Thickness 100 nm | | | | | | | | | | | |
| | Lower Film | | | | | | | | | | | |
| Heat | Al/Average Thickness | | | Cr/Average Thickness | | | Ni/Average Thickness | | | Si/Average Thickness | | |
| Treatment | 500 nm | | | 500 nm | | | 500 nm | | | 500 nm | | |
| Temperature | Kh | Ke | W_{10/1000} | Kh | Ke | W_{10/1000} | Kh | Ke | W_{10/1000} | Kh | Ke | W_{10/1000} |
| 300° C. | 148 | 0.042 | 190 | 150 | 0.038 | 188 | 153 | 0.030 | 183 | 151 | 0.029 | 180 |
| 400° C. | 144 | 0.044 | 188 | 139 | 0.037 | 176 | 135 | 0.031 | 166 | 136 | 0.033 | 169 |
| 500° C. | 111 | 0.041 | 152 | 108 | 0.036 | 144 | 108 | 0.036 | 144 | 98 | 0.036 | 134 |
| 600° C. | 80 | 0.052 | 132 | 91 | 0.052 | 143 | 79 | 0.044 | 123 | 69 | 0.052 | 121 |
| 700° C. | 65 | 0.077 | 142 | 73 | 0.071 | 144 | 73 | 0.066 | 139 | 86 | 0.089 | 175 |
| 800° C. | 88 | 0.228 | 316 | 85 | 0.187 | 272 | 69 | 0.079 | 148 | 110 | 0.356 | 466 |
| 900° C. | 169 | 0.662 | 831 | 137 | 0.594 | 731 | 74 | 0.120 | 194 | 167 | 0.987 | 1154 |

Unit: Kh [mWs/kg], Ke [mWs²/kg], W_{10/1000} [W/kg]

TABLE 6

| | Upper Film | | | | | | | | | | | |
|---|---|---|---|---|---|---|---|---|---|---|---|---|
| | Si glass/Average Thickness 100 nm | | | | | | | | | | | |
| | Lower Film | | | | | | | | | | | |
| Heat | Al/Average Thickness | | | Cr/Average Thickness | | | Ni/Average Thickness | | | Si/Average Thickness | | |
| Treatment | 1000 nm | | | 1000 nm | | | 1000 nm | | | 1000 nm | | |
| Temperature | Kh | Ke | W_{10/1000} | Kh | Ke | W_{10/1000} | Kh | Ke | W_{10/1000} | Kh | Ke | W_{10/1000} |
| 300° C. | 165 | 0.052 | 217 | 170 | 0.035 | 205 | 168 | 0.031 | 199 | 158 | 0.025 | 183 |
| 400° C. | 150 | 0.055 | 205 | 156 | 0.034 | 190 | 153 | 0.033 | 186 | 152 | 0.028 | 180 |
| 500° C. | 122 | 0.056 | 178 | 123 | 0.031 | 154 | 129 | 0.035 | 164 | 113 | 0.030 | 143 |
| 600° C. | 88 | 0.049 | 137 | 92 | 0.044 | 136 | 100 | 0.039 | 139 | 71 | 0.042 | 113 |
| 700° C. | 73 | 0.062 | 135 | 76 | 0.052 | 128 | 82 | 0.044 | 126 | 80 | 0.089 | 169 |
| 800° C. | 84 | 0.099 | 183 | 68 | 0.061 | 129 | 73 | 0.053 | 126 | 106 | 0.166 | 272 |
| 900° C. | 106 | 0.235 | 341 | 70 | 0.097 | 167 | 70 | 0.089 | 159 | 195 | 0.558 | 753 |

Unit: Kh [mWs/kg], Ke [mWs²/kg], W_{10/1000} [W/kg]

Referring to Table 5, the upper limit temperature at which the eddy current loss coefficient begins to increase was 600° C. for each dust core material with lower film 20. Referring to Table 6, the upper limit temperature for the dust core materials with aluminum and chromium as lower film 20 was 700° C., the upper limit temperature for the dust core material with nickel as lower film 20 was 800° C., and the upper limit temperature for the dust core material with silicon as lower film 20 was 600° C. By increasing the average thickness of lower film 20, it was possible to reduce the iron loss W_{10/1000} to the range from 110 W/kg to 120 W/kg.

### Example 2

Initially, the volume resistivity value of powders, the rate of change in the volume resistivity value between before and after heating of the powders, flowability of the powders, the rate of change in pressed density of the powders, a volume content of the metal magnetic particles in the dust core, and the specific resistance value of the dust core herein will be described.

In finding a volume resistivity value of powders, initially, 0.5 g powders are measured. A KBr tablet machine (Shimadzu Corporation) is used to perform pressure-forming at a pressure of 13.72 MPa. Thus, a test sample in a columnar shape is fabricated from powders.

Then, the test sample is exposed for 12 hours or longer in an environment at a temperature of 25° C. and at a relative temperature of 60%. Thereafter, the test sample is set between stainless electrodes. By using an electric resistance measurement apparatus (model 4329A manufactured by Yokogawa Hokushin Electric Corp.), a voltage of 15V is applied and resistance value R (mΩ) is measured.

Thereafter, an area A (cm²) of the upper surface and a thickness t₀ (cm) of the test (columnar) sample are measured and substituted in the expression below, thereby finding the volume resistivity value (mΩ·cm).

Volume resistivity value (mΩ·cm)=R×(A/t₀)

In finding the rate of change (%) in the volume resistivity value between before and after heating of powders, initially, the test sample in the columnar shape for measuring the volume resistivity value fabricated as above is heated for 1 hour at a temperature of 50° C. Thereafter, as in the steps described above, the volume resistivity value is measured, and the volume resistivity values before and after heating are substituted in the expression below, thereby finding the rate of change in the volume resistivity value.

Rate of change (%) in volume resistivity value between before and after heating={volume resistivity value (before heating)−volume resistivity value (after heating)}/volume resistivity value (before heating)×100

Flowability of powders is indicated by the flowability index. The flowability index is a value obtained by measuring each powder characteristic value of an angle of repose (degree), condensation (%), a spatula angle (degree), and coagulation by using Powder Tester (product name, manufactured by Hosokawa Micron Corporation), finding each index by replacing each measurement value with a numeric value based on the same reference, and calculating the total of the indices. The flowability index closer to 100 indicates better flowability.

In finding the rate of change in pressed density of powders, initially, 0.3 g sample powders is measured and placed in a cylindrical mold of φ13 mm. Then, the material powders are pressure-formed at a pressure of 98 MPa and 490 MPa using the KBr tablet machine (Shimadzu Corporation). Pressed densities CD₁ (g/cm³) and CD₅ (g/cm³) at respective pressures are found based on the thicknesses of the resultant powder layers and substituted in the expression below, thereby finding the rate of change (%) in pressed density.

Rate of change in pressed density (%)={(CD₅−CD₁)/CD₅)}×100

In finding the volume fraction of metal magnetic particles 10 contained in the dust core, initially, the volume of metal magnetic particles 10 contained in the dust core is found, based on the absolute specific gravity of sample powders and the weight of sample powders used in pressure-forming. Then, a powder mixture for the dust core which will be described later is pressure-formed to a columnar shape (φ23 mm×5 mm) at a pressure of 490 MPa, and the volume of the column after pressure-forming is measured. Then, the volume fraction of metal magnetic particles 10 contained in the dust core is calculated based on the volume of metal magnetic particles 10 contained in the dust core and the volume of the column after pressure-forming.

In finding the specific resistance value of the dust core, the dust core fabricated with a method which will be described later is used. As in the steps of measuring the volume resistivity value of powders described above, an electric resistance measurement apparatus (model 4329A manufactured by Yokogawa Hokushin Electric Corp.) is used to measure specific resistance values before and after heat treatment. In addition, rate of change (%) in specific resistance value between before and after heat treatment is found by using a specific resistance value R₀ (mΩ·cm) before heat treatment and a specific resistance value R₁ (mΩ·cm) after heat treatment and substituting the measurement values in the expression below.

Rate of change in specific resistance value (%)={(R₀−R₁)/R₀)}×100

1) Manufacturing of the Soft Magnetic Material

As metal magnetic particles 10, 500 g iron powders and sendust were prepared. The average particle size, the rate of change in pressed density, flowability, the volume resistivity value, and the volume resistivity values before and after heating of these powders were measured, and Table 7 shows the obtained values.

TABLE 7

| | Characteristics of Metal Magnetic Particle Powders | | | | | |
|---|---|---|---|---|---|---|
| | | | | | | Rate of Change in |
| Type of | | Average | | | Volume | Volume Resistivity |
| Metal | | Particle | Rate of Change in | | Resistivity | Value Between |
| Magnetic | Shape of | Size | Pressed Density | Flowability | Value | Before and After |
| Particles | Particles | (μm) | (%) | Index | (mΩ · cm) | Heating (%) |
| Iron | Granular | 65.4 | 6.3 | 53 | 183.2 | 36.3 |
| Powders | | | | | | |
| Sendust | Granular | 103.8 | 7.1 | 60 | 174.4 | 29.5 |

Thereafter, an aluminum film having an average thickness of 100 nm was formed as lower film 20 on the iron powders prepared as metal magnetic particles 10 with plating.

The metal magnetic particle powders having lower film 20 formed were introduced in 500 ml acetone and they encountered with each other by means of an agitator, thereby obtaining slurry of acetone containing metal magnetic particle powders. To the slurry, 200 ml acetone solution in which 10.0 g aluminum tributoxide was dispersed was added, and the resultant solution was stirred and mixed for 60 minutes.

Thereafter, 6.0 g phosphoric acid aqueous solution (phosphoric acid content of 85 mass %) was added to the mixture solution by taking 10-minute time, and the resultant solution was stirred and mixed for 20 minutes. The resultant mixture solution was air-dried in the draft for 3 hours, and thereafter dried for 60 minutes at a temperature of 80° C. using a drier. Through the steps above, powders of composite magnetic particles 40, indicated as sample 1 in which the inorganic compound containing Al and P was formed as upper film 30, were completed. Similarly, sendust prepared as metal magnetic particles 10 was subjected to surface treatment, thereby completing powders of composite magnetic particles 40 of sample 2.

For comparison, powders of composite magnetic particles 40 indicated as comparative samples 3 and 4 and using silica sol and alumina sol in the surface treatment for forming upper film 30 were fabricated. Table 8 shows the types of metal magnetic particles 10 and lower film 20 for resultant powders as well as conditions for the surface treatment for forming upper film 30 and the like.

TABLE 8

| | | | Surface Treatment Step of Upper film | | | | |
|---|---|---|---|---|---|---|---|
| | | | | Additive | | | |
| | Type of | Type of Lower | | | | Treated Amount Converted | |
| Powder | Metal | film | Type of | | | into Element | |
| Sample | Magnetic | (Average | Organic | | Treated Amount | Element for | Treated Amount |
| Name | Particles | Thickness) | Solvent | Type | (Parts by Mass) | Conversion | (Parts by Mass) |
| Sample 1 | Iron | Aluminum | Acetone | Aluminum Tributoxide | 0.052 | Al | 0.006 |
| | Powders | (100 nm) | | Phosphoric Acid Solution | 0.042 | P | 0.014 |
| | | | | (Phosphoric Acid 85%) | | | |
| Sample 2 | Sendust | Aluminum | Acetone | Aluminum Triisopropoxide | 0.172 | Al | 0.023 |
| | | (100 nm) | | Phosphoric Acid Solution | 0.084 | P | 0.026 |
| | | | | (Phosphoric Acid 85%) | | | |
| Comparative | Iron | Aluminum | Acetone | Silica sol | 0.257 | Si | 0.024 |
| Sample 1 | Powders | (100 nm) | | | | | |
| Comparative | Sendust | Aluminum | Water | Alumina sol | 0.326 | Al | 0.035 |
| Sample 1 | | (100 nm) | | | | | |

In addition, the rate of change in pressed density, flowability, the volume resistivity value, and the volume resistivity values before and after heating of the resultant powders of composite magnetic particles 40 were measured, and Table 9 shows the obtained values. It is noted that the coating amount of each element in upper film 30 was measured through X-ray fluorescence analysis.

TABLE 9

| | Characteristics of Composite Magnetic Particle Powders | | | | | | |
|---|---|---|---|---|---|---|---|
| | | | | | | | Rate of Change in |
| | Average | Upper Film | | | | | Volume Resistivity |
| | Particle | | Coating | Rate of Change in | | Volume | Value Between |
| Powder | Size | Element for | Amount | Pressed Density | Flowability | Resistivity Value | Before and After |
| Sample Name | (μm) | Conversion | (mass %) | (%) | Index | (mΩ · cm) | Heating (%) |
| Sample 1 | 65.6 | Al | 0.006 | 2.9 | 75 | 210.6 | 6.2 |
| | | P | 0.014 | | | | |
| Sample 2 | 104.1 | Al | 0.023 | 2.7 | 77 | 212.7 | 5.8 |
| | | P | 0.026 | | | | |
| Comparative | 65.6 | Si | 0.024 | 6.1 | 57 | 187.5 | 18.8 |
| Sample 1 | | | | | | | |
| Comparative | 104.0 | Al | 0.035 | 7.0 | 65 | 179.2 | 18.4 |
| Sample 2 | | | | | | | |

As can be seen from Table 9, in samples 1 and 2 in which upper film 30 was generated from the metal alkoxide, flowability was better than in comparative samples 1 and 2. Consequently, the rate of change in pressed density was lowered to a value less than 5%, and the volume resistivity value before and after heating could be suppressed to a level not greater than 20%.

2) Manufacturing of the Dust Core

One hundred parts by mass soft magnetic material composed of powders of composite magnetic particles 40 obtained in the previous step was mixed with 0.6 part by mass epoxy resin. The mixture powders were pressure-formed in a ring shape (10 mm×φ23 mm×5 mm) at a pressure of 4.9×10⁸ Pa, using a mold to which zinc stearate was applied. The resultant molding was heated for 30 minutes in the air at a temperature of 200° C., followed by cooling. Through the steps above, dust cores indicated as sample A, sample B, comparative sample A, and comparative sample B and formed from powders of sample 1, sample 2, comparative sample 1, and comparative sample 2 respectively were fabricated.

In addition, iron powders and sendust prepared as metal magnetic particles 10 were pressure-formed in accordance with the steps described above, thereby fabricating the dust cores indicated as comparative sample C and comparative sample D. The specific resistance values before and after heating and the rate of change in the specific resistance values of each resultant dust core as well as the volume fraction of metal magnetic particles 10 in the dust core were measured, and Table 10 shows these values together with the conditions for pressure-forming.

TABLE 10

| | | Condition for | | | | | |
|---|---|---|---|---|---|---|---|
| | | Pressure-Forming | | | | | |
| | | Organic Matter | | Characteristics of Dust Core | | | |
| | | | Amount of | Specific Resistance Value | | | |
| Molding | Type of | | Addition | Before Heating | After Heating | Rate of Change | Volume Fraction |
| Sample Name | Powders | Type | (Parts by Mass) | (mΩ · cm) | (mΩ · cm) | (%) | (%) |
| Sample A | Sample 1 | Epoxy resin | 0.6 | 235.0 | 215.5 | 8.3 | 92.4 |
| Sample B | Sample 2 | Epoxy resin | 0.6 | 238.2 | 220.1 | 7.6 | 92.7 |
| Comparative | Comparative | Epoxy resin | 0.6 | 209.9 | 140.4 | 33.1 | 88.9 |
| Sample A | Sample 1 | | | | | | |
| Comparative | Comparative | Epoxy resin | 0.6 | 200.6 | 138.4 | 31.0 | 88.3 |
| Sample B | Sample 2 | | | | | | |
| Comparative | Iron powders | Epoxy resin | 0.6 | 204.7 | 119.5 | 41.6 | 88.6 |
| Sample C | | | | | | | |
| Comparative | Sendust | Epoxy resin | 0.6 | 189.5 | 103.7 | 45.3 | 86.8 |
| Sample D | | | | | | | |

As can be seen from Table 10, in samples A and B in which upper film 30 was generated from the metal alkoxide, lowering in the specific resistance values before and after heating could be suppressed further, as compared with comparative samples A to D. In addition, the volume fraction of metal magnetic particles 10 could be improved and the dust core having excellent magnetic properties could be obtained.

The embodiments and examples disclosed above are by way of illustration and are not to be taken by way of limitation, the spirit and scope of the present invention being limited not by the examples above but by the claims and intended to include all modifications and variations within the scope of the claims.

### INDUSTRIAL APPLICABILITY

The present invention is applicable in manufacturing motor cores, electromagnetic valves, reactors, or other electromagnetic components fabricated from pressure-formed soft magnetic powders, for example.

1. A soft magnetic material comprising a plurality of composite magnetic particles;
each of said plurality of composite magnetic particles having a metal magnetic particle including iron, a lower film surrounding a surface of said metal magnetic particle and including a nonferrous metal, and an insulating upper film surrounding a surface of said lower film (and including an inorganic compound,
said inorganic compound containing at least any one element of oxygen and carbon, and
said nonferrous metal having an affinity with the at least one of oxygen and carbon that is larger than such affinity of iron.

2. The soft magnetic material according to claim 1, wherein
said nonferrous metal includes at least one selected from the group consisting of aluminum, chromium, silicon, titanium, vanadium, and nickel.

3. The soft magnetic material according to claim 1, wherein
said lower film has an average thickness of not less than 50 nm and not more than 1 μm.

4. The soft magnetic material according to claim 1, wherein
said upper film has an average thickness of not less than 10 nm and not more than 1 μm.

5. The soft magnetic material according to claim 1, wherein
said inorganic compound is composed of a compound containing at least one element selected from the group consisting of aluminum, zirconium, titanium, silicon, magnesium, iron, and phosphorus.

6. The soft magnetic material according to claim 1, wherein
said inorganic compound is at least any one of an inorganic compound generated from a metal alkoxide containing at least one element selected from the group consisting of aluminum, zirconium, titanium, silicon, magnesium, and iron and a phosphorus compound.

7. The soft magnetic material according to claim 6, having a rate of change in pressed density less than 5%.

8. The soft magnetic material according to claim 6, having a rate of change in a volume resistivity value between before and after heating of at most 20%.

9. A method of manufacturing the soft magnetic material according to claim 6, comprising:
lower film forming step of forming said lower film on the surface of said metal magnetic particle; and
upper film forming step of, subsequent to said lower film forming step, adding a solution of a metal alkoxide to a suspension obtained by dispersing said metal magnetic particles in an organic solvent, air-drying resultant suspension, and drying resultant powders at a temperature in a range from at least 60° C. to at most 120° C.

10. The method of manufacturing the soft magnetic material according to claim 9, wherein
said upper film forming step includes the step of further adding a phosphoric acid solution to said suspension to which the solution of the metal alkoxide has been added.

11. A dust core fabricated using the soft magnetic material according to claim 1.

12. The dust core according to claim 11, further comprising an organic matter disposed between said plurality of composite magnetic particles to join said plurality of composite magnetic particles together and including at least one selected from the group consisting of a polyethylene resin, a silicone resin, a polyamide resin, a polyimide resin, a polyamide imide resin, an epoxy resin, a phenolic resin, an acrylic resin, and a polytetrafluoroethylene.

13. A method of manufacturing the dust core according to claim 1 1, comprising the steps of:
by pressure-forming said plurality of composite magnetic particles, forming a molding; and
heat-treating said molding at a temperature of not less than 500° C.

14. A soft magnetic material comprising a plurality of composite magnetic particles;
each of said plurality of composite magnetic particles having a metal magnetic particle including iron, a lower film surrounding a surface of said metal magnetic particle and including a nonferrous metal, and an insulating upper film surrounding a surface of said lower film and including an inorganic compound,
said inorganic compound containing at least any one element of oxygen and carbon, and
said nonferrous metal having a diffusion coefficient with respect to the at least one of oxygen and carbon that is smaller than such diffusion coefficient of iron.

15. The soft magnetic material according to claim 14, wherein
said nonferrous metal includes at least one selected from the group consisting of aluminum, chromium, silicon, titanium, vanadium, and nickel.

16. The soft magnetic material according to claim 14, wherein
said lower film has an average thickness of not less than 50 nm and not more than 1 μm.

17. The soft magnetic material according to claim 14, wherein
said upper film has an average thickness of not less than 10 nm and not more than 1 μm.

18. The soft magnetic material according to claim 14, wherein
said inorganic compound is composed of a compound containing at least one element selected from the group consisting of aluminum, zirconium, titanium, silicon, magnesium, iron, and phosphorus.

19. The soft magnetic material according to claim 14, wherein
said inorganic compound is at least any one of an inorganic compound generated from a metal alkoxide containing at least one element selected from the group consisting of aluminum, zirconium, titanium, silicon, magnesium, and iron and a phosphorus compound.

20. The soft magnetic material according to claim 19, having a rate of change in pressed density less than 5%.

21. The soft magnetic material according to claim 19, having a rate of change in a volume resistivity value between before and after heating of at most 20%.

22. A method of manufacturing the soft magnetic material according to claim 19, comprising the steps of:
lower film forming step of forming said lower film on the surface of said metal magnetic particle; and
upper film forming step of, subsequent to said lower film forming step, adding a solution of a metal alkoxide to a suspension obtained by dispersing said metal magnetic particles in an organic solvent, air-drying resultant suspension, and drying resultant powders at a temperature in a range from at least 60° C. to at most 120° C.

23. The method of manufacturing the soft magnetic material according to claim 22, wherein
said upper film forming step includes the step of further adding a phosphoric acid solution to said suspension to which the solution of the metal alkoxide has been added.

24. A dust core fabricated using the soft magnetic material according to claim 14.

25. The dust core according to claim 24, further comprising an organic matter disposed between said plurality of composite magnetic particles to join said plurality of composite magnetic particles together and including at least one selected from the group consisting of a polyethylene resin, a silicone resin, a polyamide resin, a polyimide resin, a polyamide imide resin, an epoxy resin, a phenolic resin, an acrylic resin, and a polytetrafluoroethylene.

26. A method of manufacturing the dust core according to claim 24, comprising the steps of:
by pressure-forming said plurality of composite magnetic particles, forming a molding; and
heat-treating said molding at a temperature of not less than 500° C.
